(19) United States
(12) Patent Application Publication
(10) Pub. No.: US 2002/0096506 A1
(43) Pub. Date: Jul. 25, 2002

(54) Electrically heated aircraft deicer panel

(76) Inventors: Thomas R. Moreland, Diamond, OH (US); Kurt M. Tauscher, North Canton, OH (US)

Correspondence Address: Renner, Otto, Boisselle & Sklar, LLP, 19th Floor, 1621 Euclid Avenue, Cleveland, OH, 44115-2191, US

(21) Appl. No.: 09/768,885

(22) Filed: Jan. 23, 2001

Related U.S. Application Data
(60) Provisional application No. 60/239,796, filed on Oct. 12, 2000.

(51) Int. Cl. B60L 1/02

(52) U.S. Cl. 219/202; 219/545

(57) ABSTRACT

An aircraft deicer panel (10) including an inner support layer (20) which is electrically insulating, an outer cover layer (26) which is thermally conducting, a heater layer (22) which is electrically insulating, and an electrical heating element (28) attached to the heater layer (22). The heating element (28) comprises an electrically conductive strand (30) stitched in the layer (22) in a heat-dissipating pattern such as, for example, a winding path of closely spaced and sharply curved turns formed by a continuous length of the electrically conductive strand (30). During manufacture of the aircraft panel (10), an industrial sewing machine can be programmed to stitch the desired pattern of the electrically conductive strand (30).

### RELATED APPLICATIONS

This application claims priority under 35 U.S.C. §119(e) to U.S. Provisional Patent Application No. 60/239,796 filed on Oct. 12, 2000. The entire disclosure of this provisional application is hereby incorporated by reference.

### FIELD OF THE INVENTION

The present invention relates generally as indicated to an electrically heated aircraft deicer panel and, more particularly, to a panel having an electrical heating element attached to an intermediate layer in a heat-dissipating pattern.

### BACKGROUND OF THE INVENTION

An aircraft can be periodically exposed to conditions of precipitation and low temperatures which can cause the forming of ice on its wings and other exposed surfaces. If the aircraft is to perform sufficiently in flight, it is important that this ice be removed whereby deicers are usually installed on the aircraft. Of particular interest in the present invention is an electrically heated aircraft deicer which typically comprises a deicing panel that is installed on the aircraft. For example, a panel can be secured to each of the aircraft's wings to prevent ice accumulation thereon.

A deicer panel will typically include an inner support layer, a heater layer, a thermal conducting layer, and an outer cover layer. An electrical heating element is attached to the heater layer, the layers are bonded together, and the inner support layer is cemented to the aircraft wing. In operation, the heating element is electrically heated whereby heat is transmitted to the thermal conducting layer which uniformly distributes the heat to the outer cover layer to remove accumulated ice therefrom.

The heating element commonly comprises an electrically conductive wire that is attached to the heater layer in a heat-dissipating pattern. Typically, the heat-dissipating pattern comprises a winding path of closely spaced and sharply curved turns formed by a continuous length of wire. To attach the wire, the breezeside of the heater layer is coated with an adhesive and locating pins are placed in accordance with the desired pattern, for example, at the corners of each of the many turns of the coils. The electric wire is then wound around the locating pins and adhesively secured to the layer. In view of the complexity and closeness of most heat-dissipating patterns, placing of the locator pins and/or winding of the wire around the locator pins can be tedious and time-consuming tasks. Moreover, automation of these tasks has proved to be difficult.

### SUMMARY OF THE INVENTION

The present invention provides an aircraft deicer panel which eliminates the need for adhesives, locating pins, and other inconveniences associated with conventional methods for forming wire patterns on the panel's heater layer. Additionally, the deicer panel of the present invention lends itself to automation.

More particularly, the present invention provides an aircraft deicer panel wherein an electrically conductive strand is stitched in the heater layer in a heat dissipating pattern. Since the electrically conductive strand is attached by stitching, the need for adhesives is eliminated. Also, a heat-dissipating pattern that comprises a winding path of closely spaced and sharply curved turns is especially suited for such stitching and, in any event, the stitching can be accomplished without locator pins. Further, because industrial sewing machines are available which can be programmed to stitch the desired pattern, this stage of the panel-making process can be easily automated.

These and other features of the invention are fully described and particularly pointed out in the claims. The following description and annexed drawings set forth in detail a certain illustrative embodiment of the invention, this embodiment being indicative of but one of the various ways in which the principles of the invention can be employed.

### DRAWINGS

FIG. 1 is a schematic illustration of a deicer panel according to the present invention installed on an aircraft.

FIG. 2 is a plan view of the deicer panel in a flat condition, certain layers of the panel being removed to show the heat-dissipating pattern of the heating element.

FIG. 3 is a top view of a portion the heater layer of the deicer panel enlarged to show the stitch arrangement of an electrically conductive strand.

FIG. 4 is a bottom view of a portion of the heater layer of the deicer panel enlarged to show the stitch arrangement of a dielectric strand.

FIGS. 5A-5D are schematic views of an exemplary sewing technique for stitching the strands in the heater layer.

### DETAILED DESCRIPTION

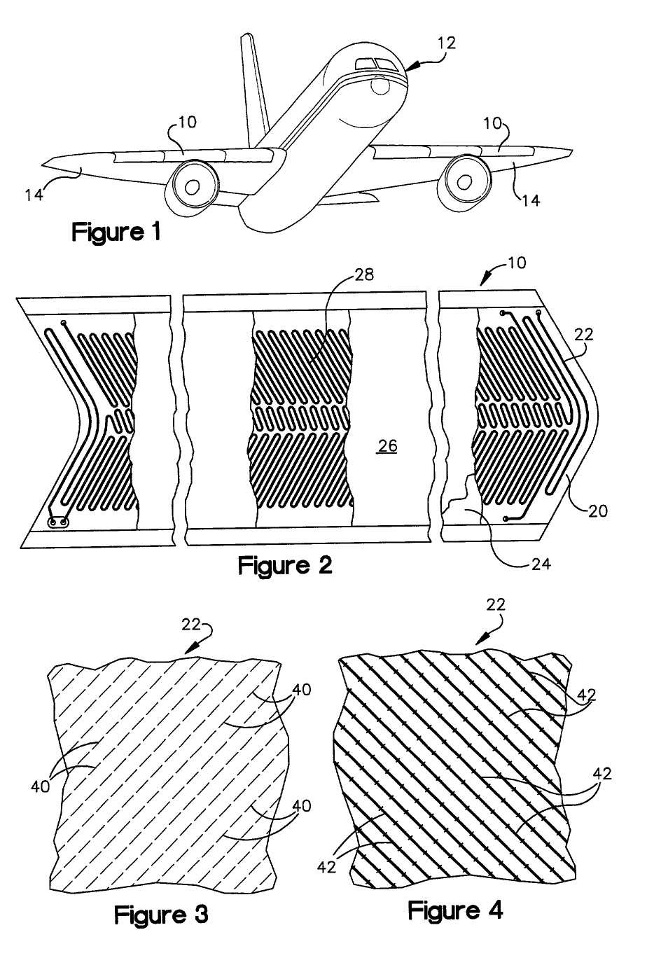

Referring now to the drawings, and initially to FIG. 1, deicer panels 10 according to the present invention are shown installed on an aircraft 12. More particularly, a panel 10 is secured to each of the aircraft's wings 14 to prevent ice accumulation thereon. Modified version of the panels 10 can be used on other ice-susceptible structural members of the aircraft 12 such as, for example, stabilizers, engine inlets and/or rotors.

Referring now to FIG. 2, the panel 10 is shown in a flat condition. The illustrated panel 10 includes an inner support layer 20, a wire-containing layer 22, a thermal conducting layer 24, an outer cover layer 26, and an electrical heating element 28 attached to the layer 22. The layers are bonded together and the inner support layer 20 is attached (e.g., cemented) to the aircraft wing 14. In operation, the heating element 28 is electrically heated whereby heat is transmitted to the thermal conducting layer 24 which uniformly distributes the heat to the cover layer 26 to remove accumulated ice therefrom.

The layers 20, 22, 24, and 26 are made of materials that will adhere to each other to provide an integral structure, that have a sufficient flexibility for installation but an appropriate stiffness for operation, and that maintain their desired properties at a wide temperature range to accommodate high manufacturing temperatures and low aircraft operating temperatures. Also, cost, ease in manufacture, and weight will probably be considerations in the selection of the layer materials.

The inner support layer 20 is made of a material that provides electrical insulation between the heating elements 28 and the wing 14 (e.g., rubber coated fiberglass fabric). The heater layer 22 is made of a material that provides an appropriate attachment medium for the heating element 28, that provides electrical insulation, and that provides a sufficient thermal conductivity to transfer the heat from the element 28 to the layer 24 (e.g., cured rubber, fiberglass weaves, composite adhesives). The thermal conducting layer 24 is made of a material that provides electrical insulation but at the same time effectively diffuses and rapidly conducts heat from the heating element 28 to the outer cover layer 26 ( e.g., rubber coated fiberglass fabric). The cover layer 26 is made of a material that has a high thermal conductivity, that is resistant to abrasion/corrosion, and that is sufficiently stiff/strong for protective purposes (e.g., sheet aluminum alloy, stainless steel, magnesium alloy).

As is shown in FIG. 2, the heat-dissipating pattern of the heating element 28 comprises a winding path of closely spaced and sharply curved turns extending substantially the entire span of the panel 10. As is shown in FIGS. 3 and 4, the heating element 28 comprises an electrically conductive strand 30 which is stitched in the heating layer 22 in the heat-dissipating pattern. The strand 30 is made of a suitable metal (e.g., aluminum bronze alloy, nickel-chromium alloy, nickel-chromium-iron alloy, or nickel-copper alloy) which is flexible enough to accommodate to the sewing process.

In the illustrated embodiment, the heating element 28 also comprises a dielectric strand 32 made of a suitable electrically non-conducting material (e.g., nylon). On the breezeside of the heater layer 22 (i.e., closest to the outer layer 26) the electrically conductive strand 30 forms a series of linear stitches 40. On the bondside of the heater layer 22 (i.e., closest to the inner layer 20) the dielectric strand 32 forms a series of linear stitches 42.

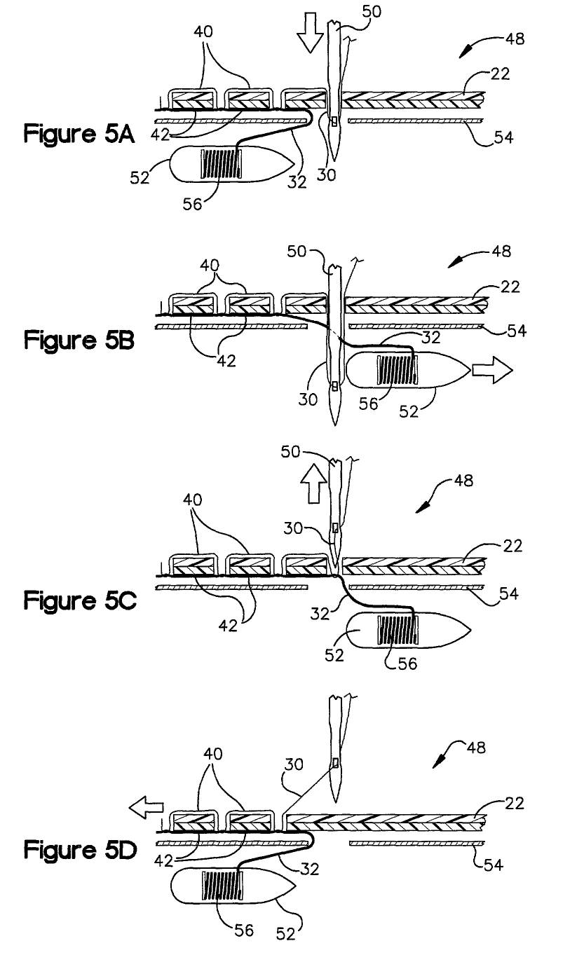

The heating element 28 can be formed on an industrial sewing machine 48 having a needle 50, a shuttle 52, and a throat plate 54 as shown schematically in FIGS. 5A-5D. The electrically conductive strand 30 is carried by the needle 50 and the dielectric strand 32 is unreeled from a bobbin 56 carried in the shuttle 52. The descending needle 50 penetrates the layer 22 and carries the electrically conductive strand 30 along. (FIG. 5A.) When the needle 50 rises again, the strand 30 forms a loop on the underside of the layer 22. The shuttle 52 (which contains the bobbin 56 of the dielectric strand 32) goes through this loop and pulls the dielectric strand 32 along behind it. (FIG. 5B.) The dielectric strand 32 is thus enclosed in the loop of the electrically conductive strand 30. The layer 22 is then moved forward while the needle 50 remains stationary and the shuttle 52 returns to its initial position. This causes the slack loop to be pulled tight and close up, so that the two strands 30 and 32 interlock in the middle of the layer 22. (FIG. 5C.) When the forward movement of the layer 22 is completed, the process is repeated to form another stitch set 40/42. (FIG. 5D.)

One can now appreciate that the present invention provides a deicer panel 10 and a method of making such a panel which eliminates the need for adhesives, locating pins, and other inconveniences associated with conventional methods for forming wire patterns on the heater layer. Also, industrial sewing machines are available with two-dimensional drives (see e.g., U.S. Pat. No. 5,809,918) which can be programed to automatically stitch the desired heat-dissipating pattern whereby the present invention lends itself to automation.

Although the invention has been shown and described with respect to a certain preferred embodiment, equivalent and obvious alterations and modifications will occur to others skilled in the art upon the reading and understanding of this specification. The present invention includes all such alterations and modifications and is limited only by the scope of the following claims.

1. An aircraft deicer panel comprising an inner support layer which is electrically insulating, an outer cover layer which is thermally conducting, a heater layer which is electrically insulating, and an electrical heating element attached to the heater layer;
wherein the electrical heating element comprises an electrically conductive strand stitched in the heater layer in a heat-dissipating pattern.

2. A deicer panel as set forth in claim 1, wherein the heat-dissipating pattern comprises a winding path of closely spaced and sharply curved turns formed from a continuous length of the electrically conductive strand.

3. A deicer panel as set forth in claim 1, wherein the heater layer is made from cured rubber, fiberglass, or composite adhesive.

4. A deicer panel as set forth in claim 1, wherein the electrically conductive strand is made of aluminum bronze alloy, nickel-chromium alloy, nickel-chromium-iron alloy, or nickel-copper alloy.

5. A deicer panel as set forth in claim 1, wherein the electrical heating element further comprises a dielectric strand which is used to secure the electrically conductive strand in the heat-dissipating pattern.

6. A deicer panel as set forth in claim 1, wherein the electrically conductive strand forms a series of linear stitches on a breezeside of the heater layer.

7. A deicer panel as set forth in claim 6, wherein the electrical heating element further comprises a dielectric strand forming a series of linear stitches on a bondside of the heater layer.

8. A deicer panel as set forth in claim 7, wherein the electrically conductive strand and the dielectric strand interlock between adjacent stitches.

9. A deicer panel as set forth in claim 1, further comprising a thermal conducting layer which is electrically insulating and which is positioned between the heater layer and the outer cover layer.

10. In combination, an aircraft and a deicer panel as set forth in claim 1, the deicer panel being secured to an ice-susceptible member of the aircraft.

11. A combination as set forth in claim 10, wherein the ice-susceptible member is a wing of the aircraft.

12. In combination, an aircraft and a deicer panel as set forth in claim 1 secured to each wing of the aircraft.

13. A method of making the aircraft deicer panel of claim 1, said method comprising the steps of:
stitching the electrically conductive wire into the heater layer in the heating-dissipating pattern; and
joining the stitched heater layer to the inner support layer and the outer cover layer.

14. A method as set forth in claim 13, wherein said stitching step is performed by a sewing machine.

15. A method as set forth in claim 14, wherein said stitching step comprises programming the sewing machine to automatically stitch the heat dissipating pattern.

16. A method of making an aircraft deicer panel, comprising the steps of:
providing an inner support layer which is electrically insulating, an outer cover layer which is thermally conducting, and a heater layer which is electrically insulating;
stitching an electrically conductive strand in the heater layer in a heat-dissipating pattern; and
joining the inner support layer, the heater layer, and the cover layer together.

17. A method as set forth in claim 16, further comprising the step of positioning a thermal conducting layer which is electrically insulating between the heater layer and the outer cover layer.

18. A method as set forth in claim 17, wherein said stitching step comprises stitching a winding path of closely spaced and sharply curved turns from a continuous length of the electrically conductive strand to form the heat-dissipating pattern.

19. A method as set forth in claim 18, wherein said stitching step comprises using a dielectric strand to secure the electrically conductive strand in the heat-dissipating pattern.

20. A method as set forth in claim 19, wherein said stitching step comprises forming a series of linear stitches on a breezeside of the heater layer with the electrically conductive strand.

21. A method as set forth in claim 20, wherein said stitching step comprises forming a series of linear stitches on a bondside of the heater layer with a dielectric strand.

22. A method as set forth in claim 21, wherein said stitching step comprises interlocking the electrically conductive strand with the dielectric strand to separate adjacent stitches.

23. A method as set forth in claim 16, wherein said stitching step comprises programming a sewing machine to automatically stitch the heat dissipating pattern.
